(19) United States
(12) Patent Application Publication
(10) Pub. No.: US 2020/0111132 A1
(43) Pub. Date: Apr. 9, 2020

(54) PACING FOR ASSET DELIVERY IN A COMMUNICATIONS NETWORK

(71) Applicant: INVIDI Technologies Corporation, Princeton, NJ (US)

(72) Inventors: David Ballantyne, Edmonton (CA); Samira Sadeghi, Edmonton (CA); Dale Hagglund, Edmonton (CA); Daniel C. Wilson, Edmonton (CA)

(21) Appl. No.: 16/382,023

(22) Filed: Apr. 11, 2019

Related U.S. Application Data
(60) Provisional application No. 62/656,176, filed on Apr. 11, 2018.

(51) Int. Cl. G06Q 30/02

(52) U.S. Cl. CPC G06Q 30/0272; G06Q 30/0267; G06Q 30/0277; G06Q 30/0244

(57) ABSTRACT

A pacing platform and functionality allows for controlling the pace of delivery of addressable assets in an addressable asset delivery system (100). The illustrated system (100) generally includes an asset delivery order system (102), a decisioning system (104), UEDs (106) and delivery platforms (108). The system (100) allows for delivery of targeted assets to users of UEDs (106) in connection with asset delivery opportunities of programming provided by one or more program delivery networks (122). The system (100) allows for more even pacing of assets delivered by individual UEDs while still collectively fulfilling the campaigns entered via the order system (102). In addition, the invention allows for operation of the order system (102) so as to avoid accepting campaign requests that likely cannot be fulfilled.

### CROSS-REFERENCE TO RELATED APPLICATION

This application is a non-provisional of U.S. Provisional Application No. 62/656,176, entitled, “PACING FOR ASSET DELIVERY IN A COMMUNICATIONS NETWORK,” filed on Apr. 11, 2018. The contents of the above-noted application are incorporated by reference herein as if set forth in full and priority to this application is claimed to the full extent allowable under U.S. law and regulations.

### FIELD

The present invention generally relates to delivery of assets in a communications network and, in particular, to pacing the delivery of assets so as to satisfy, as much as possible, delivery targets while optimizing separation between successive deliveries.

### BACKGROUND

Considerable effort has been expended on optimizing delivery of assets, such as commercials, product placement advertisements, public service announcements, or other information, in communications networks. The case of delivering advertisements in broadcast networks (e.g., television or radio) is illustrative. In such networks, an advertiser may develop a campaign for an advertisement. The campaign is generally designed to optimize the effectiveness of the advertisement and may specify a total number of desired impressions (e.g., plays or viewings) for the advertisement, a target audience (e.g., specified in terms of demographics), total number of impressions for a given network user, a minimum time separation between successive impressions for a given network user, and other delivery goals or constraints. The information defining a campaign can be specified in discussions with a sales agent or entered on a contracting platform. In any event, an important objective is to deliver advertisements in delivery opportunities (e.g., commercial breaks, product placement spots, etc.) such that the delivery opportunities are optimally utilized and the campaign parameters of advertisers are satisfied.

Conventionally, in broadcast networks such as TV networks, this process was relatively straightforward. Advertisers could buy specific advertising spots, e.g., the first spot in the first commercial break of a given program on a given channel. All viewers tuned to that channel would then receive the same advertisement, e.g., whatever advertisement was associated with the winning bid for that spot. Advertisers could construct a campaign by purchasing a desired number of spots at desired times using ratings for guidance.

The situation has been complicated considerably with the advent of addressable advertising. In addressable advertising systems, different viewers of a given program may receive different advertisements during a given commercial break depending, for example, on the actual or estimated demographics or other characteristics of the household or viewer. Consequently, a user equipment device (e.g., a set top box, television, streaming device or the like) or other network platform may make a selection, from a set of available ads, of what ad to deliver in a given spot. These selections complicate the process of contracting for ad delivery, satisfying ad campaign parameters, and verifying satisfaction of an ad campaign parameters.

One current approach to scheduling delivery of advertisements in the addressable context involves establishing criteria for prioritizing ads for delivery. For example, such criteria may specify prioritization values for ads based on revenues generated by ad delivery, whether additional impressions are needed to catch up to a desired pace for ad delivery, or how close it is to the end of a campaign, among other things. Such priorities are intended to influence individual ad selection decisions towards meeting defined system objectives. However, such priority-based selection systems have been found to result in uneven distribution of impressions over time. For example, based on system-wide priorities, many user devices may make the same ad delivery decision at the same time. This may result in a sudden surge in the total number of impressions for a given ad that, in turn, results in lowering the priority for that ad. The cumulative effect can be uneven pacing of ad delivery which may not be desired.

### DESCRIPTION OF THE INVENTION

The present invention is directed to a system and associated functionality for use in pacing the delivery of assets in a communications network. In one implementation, the system implements a substantially uniform probability, across all assets that are available for delivery with respect to an asset delivery opportunity, that any asset will be selected for delivery. In this manner, the system avoids delivery surges associated with priority-based selection schemes. Nonetheless, the system allows for asset selections that comply with minimum spacing requirements of an asset delivery campaign. The system can thus achieve more steady pacing of asset delivery to satisfy campaign goals, while allowing for pacing adjustments that can be executed across the network with simple commands and without substantial computational complexity. The system can also be used predictively to meter asset delivery requests that are accepted so as to avoid over-subscribing asset delivery inventory.

In accordance with one aspect of the present invention, a method is provided for use in pacing the delivery of assets in a communications network. The method involves identifying, for each user equipment device of a set of managed user equipment devices of the communications network, a set of assets that are available for delivery in connection with a first asset delivery opportunity of a set of asset delivery opportunities. For example, the user equipment device may include a set top box, a television, a streaming device or other device. The communications network may be a broadcast network, a data network for streaming content, or may include both broadcast and point-to-point delivery functionality. In the last regard, in one implementation, programming content may be delivered via broadcast mechanisms whereas assets may be delivered via a data network. The set of managed user equipment devices may include all user equipment devices of the network, a set of user equipment devices that are being managed for addressable asset delivery, a set of user equipment devices that are tuned to a channel where an asset delivery opportunity is available, or other subset of user equipment devices of the network. The set of asset delivery opportunities may include, for example, asset delivery opportunities occurring during an asset campaign or another unit of time, or opportunities of a given channel or set of channels.

The method further involves determining, in connection with a first asset delivery opportunity, a set of active asset delivery requests. Each of the asset delivery requests identifies a particular asset and is associated with an aggregate delivery target regarding a desired number of deliveries of the particular asset, and a delivery time period for satisfying the desired number of deliveries. Thus, an asset delivery request may specify a total number of impressions that are desired to be delivered over a campaign time period, e.g., one week. The set of active asset delivery requests may include all asset delivery requests that are pending at the time of the first asset delivery opportunity, a subset of all pending asset delivery requests that are available based on constraints associated with those requests, or another subset of all pending asset delivery requests.

For each user equipment device of the set of managed user equipment devices, an asset selection process may then be established. For example, the asset selection process may be established such that each active asset of the active asset delivery requests has a substantially uniform probability of being selected for each asset selection event associated with the set of asset delivery opportunities. That is, the probability of any active asset being selected is independent of any prioritization information based on revenues, progress towards a campaign goal, or the like. In this regard, prioritization information, wherein one active and available asset is prioritized in relation to another active and available asset, is distinguished from pacing information which does not make such relative distinctions between assets.

The process further involves determining, for each asset delivery request of the set of active asset delivery requests, pacing information relating to a base delivery separation time wherein, for each user equipment device, the effective time separation between successive deliveries of a first asset is a function of a first portion, based on the base time separation, and a second portion based on the selection process amongst the assets available at that time for the user equipment device that depends on the substantially uniform probability noted above. For example, a base time separation value may be selected that is equal to or greater than a minimum time separation specified in an asset delivery request but no greater than that base time separation necessary so that the aggregate of the effective deliveries across all user equipment devices is such that there is an even pacing of deliveries that at least meet the aggregate delivery target of that asset delivery request.

This process may further determine, for any set of asset delivery requests and a new proposed asset delivery request, a mechanism to either accept or reject the new asset delivery request. The requisite base time separation values may be selected so that every one of the set of asset delivery requests and the new asset delivery request will, in composite, all meet the aggregate delivery target of each of said asset delivery requests, and the new asset delivery request may be accepted if there are base time separation values greater than zero that permit this composite expected outcome, and rejected if no such time separation values can be selected. More specifically, the new asset delivery request may be rejected if accepting it would cause the base time separation values to violate the minimum time separation of any asset delivery request. In making this determination, the time period being analyzed may be broken into smaller units for analysis. That is, it may be possible to accommodate the new asset delivery request without violating the minimum time separation for any asset delivery request if appropriate base time separation values are selected for each of the smaller units of the time period being analyzed. In some cases, where the operating rules of the system permit, a previously accepted asset delivery request may be modified or canceled, or the new request may be modified, rather than rejecting the new request.

Finally, the noted process involves monitoring an actual delivery parameter for the first asset and selectively adjusting the pacing information based on the monitored actual delivery parameter. For example, some or all of the managed user equipment devices may generate asset delivery reports. Such asset delivery reports may identify assets delivered in connection with particular asset delivery opportunities. Based on these asset delivery reports, the system may determine whether suitable progress is being made towards satisfying the aggregate delivery target for individual assets. The pacing information, for example, a time separation value for a particular asset, may be increased or decreased based on analysis of the asset delivery reports. Where the pacing information includes a time separation value, it will be appreciated that the time separation value need not have a predefined relation to the actual delivery parameter and the time separation value may be determined empirically and adjusted to achieve the desired result.

Corresponding structure for executing the functionality described above is also provided in accordance with the present invention. In this regard, the noted functionality may be executed on one or more processors of each user equipment device, on a separate network platform such as a headend or associated processing equipment, or the functionality may be distributed across multiple processors on multiple machines at different locations. In one implementation, a user equipment device includes a first port for receiving content from a broadcast network, a second port for receiving content from a data network, storage for storing a set of assets, and a processing system for executing asset selection functionality. Alternatively, the selection functionality may be executed on a platform separate from the user equipment device and direction may be provided to the user equipment device reflecting the selection decision. In addition, a network platform may include equipment for inserting programming into a broadcast network, equipment for delivering assets to user equipment devices via a data network, and a processing system for determining pacing information in delivering pacing information and/or asset selection information to user equipment devices.

Further information concerning the invention is set forth in the description below. For example, a system is described for addressable asset delivery and thus provides an exemplary network context where the invention may be implemented. That system involves addressable asset delivery for broadcast cable television. Programming is provided via a cable television network whereas assets can be provisioned from a cloud-based system via a data network such as the Internet. It will be appreciated that various aspects of the invention are not limited to the broadcast television context or to such hybrid cable/data network mechanisms. For example, the programming may be delivered by streaming in a data network and the assets may be delivered via a cable or satellite television network. The description below nonetheless sets forth exemplary user equipment devices and other network platforms where the functionality of the present invention can be executed. The description also sets forth specific examples of an asset pacing system in accordance with the present invention.

### BRIEF DESCRIPTION OF THE DRAWINGS

For a more complete understanding of the present invention and further advantages thereof, reference is now made to the following detailed description taken in conjunction with the drawings in which:

FIG. 1 is a schematic diagram of an addressable asset delivery system in accordance with the present invention;

FIG. 2 is a flowchart showing a process for pacing delivery of assets in the addressable asset delivery system of FIG. 1; and

FIG. 3 is a flowchart showing a process for using the pacing functionality of the present invention to control the operation of the asset delivery order platform of the system of FIG. 1.

### DETAILED DESCRIPTION

The present invention relates to pacing the delivery of assets in communications networks. The assets include content intended for dissemination in one more communication networks to yield impressions according to campaign parameters including constraints concerning repeated delivery to individual network users. A common form of assets for which such campaigns are designed is advertisements, and especially advertisements for broadcast or multicast networks or campaigns that are fulfilled at least in part through asset deliveries in such networks. The invention is also applicable in connection with other delivery modes (e.g., unicast, VOD) where the user device exercises some degree of autonomy in executing the selection of assets for delivery to a user or users. In the description below, the invention is set forth in the context of ad campaigns that are fulfilled at least in part via addressable asset delivery in television networks. However, it will be appreciated that the invention is not limited to this context.

The following description is divided into a number of sections. In the first section, a broadcast television network implementing an addressable asset delivery is described. Thereafter, the pacing functionality is described. Finally, the operation of the pacing system is described in the context of asset delivery pacing for executing a campaign and pacing analysis for controlling the operation of an asset delivery order system.

### 1. System Architecture

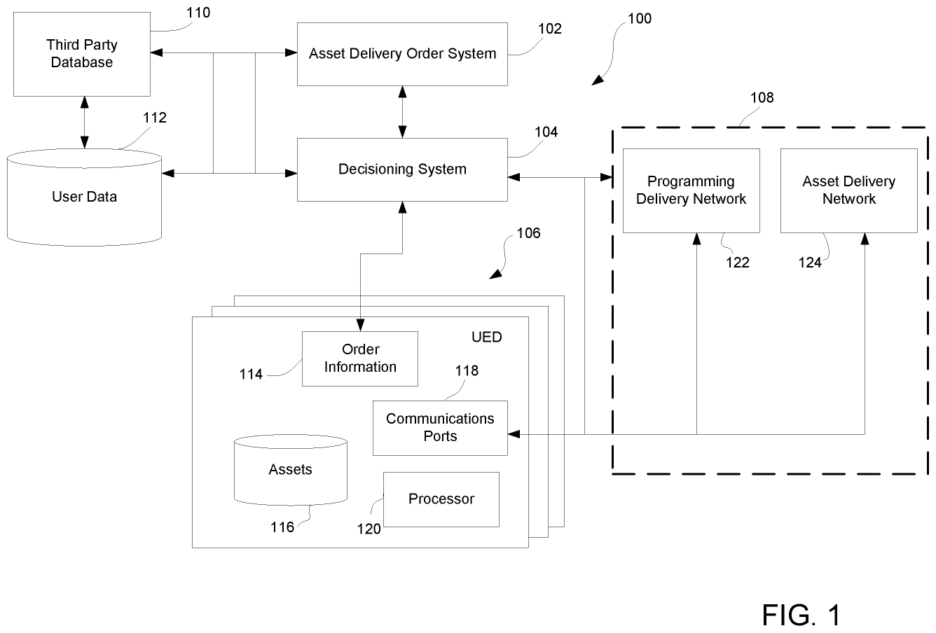

FIG. 1 shows an addressable asset delivery system 100 in accordance with the present invention. For purposes of illustration, the system 100 is described in relation to providing television programming, though the system is applicable in connection with other communications networks. Television programming can be provided, for example, in traditional linear mode, VOD mode, and streaming or over-the-top modes. Such systems are described in more detail in U.S. patent application Ser. No. 11/332,772, filed Jan. 12, 2006, entitled, “ASSET DELIVERY REPORTING IN A BROADCAST NETWORK”; U.S. patent application Ser. No. 12/913,338, filed Oct. 27, 2010, entitled, “ASSET TARGETING SYSTEM FOR LIMITED RESOURCE ENVIRONMENTS”; U.S. patent application Ser. No. 15/670,165, filed Aug. 7, 2017, entitled, “THIRD PARTY DATA MATCHING FOR TARGETING ADVERTISING”; U.S. patent application Ser. No. 15/967,909, filed May 1, 2018, entitled, “TARGETED ADVERTISING IN UNICAST, MULITCAST AND HYBRID DISTRIBUTION SYSTEM CONTEXTS”; and U.S. patent application Ser. No. 15/403,837, filed Jan. 11, 2017, entitled, “MANAGING ADDRESSABLE ASSET CAMPAIGNS ACROSS MULTIPLE DEVICES”; all of which are incorporated herein by reference.

The illustrated system 100 generally includes an asset delivery order system 102, a decisioning system 104, UEDs 106 and delivery platforms 108. The system 100 allows for more even pacing of assets delivered by individual UEDs while still collectively fulfilling the campaigns entered via the order system 102. In addition, the invention allows for operation of the order system 102 so as to avoid accepting campaign requests that likely cannot be fulfilled.

The system 100 allows for delivery of targeted assets to users of UEDs 106 in connection with asset delivery opportunities of programming provided by one or more program delivery networks 122. Such asset delivery opportunities can take a variety of forms including commercial breaks that are interspersed with or temporally adjacent to programming, product placement ads that are overlaid or digitally inserted into the programming content, pop-up ads or other opportunities to present assets in connection with programming. Addressable asset delivery opportunities are asset delivery opportunities where different assets may be delivered to different network users in connection with an asset delivery opportunity of given programming. For example, an asset may be targeted to an individual, a UED, or a household based on demographics, interests, location, or any other information that is deemed (e.g. by an asset provider) useful for targeting assets. In many cases, only a portion of the asset delivery opportunities are available for delivery of addressable assets, e.g., addressable advertising breaks or addressable spots within breaks.

There are a variety of delivery mechanisms and modalities that can be used to deliver addressable assets in accordance with the present invention. For example, addressable assets can be provided to the UED in real time or forwarded to the UED ahead of time. In a real-time system, the UED can be switched, at the appropriate time for delivery of the addressable asset, to bandwidth carrying the appropriate asset. In forward and store implementations, asset options can be stored at the UED and retrieved from storage for delivery in connection with an appropriate addressable asset delivery opportunity. In either case, the assets can be provided via the same network used to deliver the programming or a separate network. The transmission mode for providing the assets to the UED can be broadcast, multicast, or unicast. Real time and forward and store implementations are described in U.S. patent application Ser. No. 11/332,772, filed Jan. 12, 2006, entitled, “ASSET DELIVERY REPORTING IN A BROADCAST NETWORK.” Transmission of assets via a separate, IP network is described in U.S. patent application Ser. No. 15/403,827, filed Jan. 11, 2017, entitled, “MANAGING ADDRESSABLE ASSET CAMPAIGNS ACROSS MULTIPLE DEVICES”; and U.S. patent application Ser. No. 15/403,837, filed Jan. 11, 2017, entitled, “MANAGING ADDRESSABLE ASSET CAMPAIGNS ACROSS MULTIPLE DEVICES.” Multicast transmission of assets is described in U.S. Pat. Appl. Ser. No. 62/742,118, filed Oct. 5, 2018, entitled, “SYSTEM FOR MULTICAST TRANSMISSION OF TARGETED ASSETS.” Real time transmission of asset options in a satellite TV network is described in U.S. patent application Ser. No. 15/403,847, filed Jan. 11, 2017, entitled, “SATELLITE SWITCHING FOR ADDRESSABLE ASSET DELIVERY.” All of the applications/patents noted above are incorporated herein by reference.

Addressability involves making a selection among available assets for a user or users of a UED. The selection process may be executed at the UED 106, at one or more separate platforms, or may be distributed over the UED 106 and one or more separate platforms. As described below, the pacing functionality involves semi-autonomous decisions for UEDs, but may be implemented at various locations. In this regard, the UED 106 may execute logic for executing the pacing functionality. Additionally or alternatively, logic may be implemented for a specific UED at one or more separate platforms and then appropriate messaging may be used to direct delivery of the appropriate asset by appropriate UEDs in a process sometimes termed “house painting” (though UEDs may be directed independent of and at a finer level than “households”). These delivery modes are described in the patents and applications referenced above.

Referring again to FIG. 1, campaign parameters defining a campaign may be entered via the asset delivery order system 102. The parameters may be entered directly by an asset provider or agent who can access and automated platform, or may be entered manually working with personnel operating the order platform 102. A typical campaign may specify a target audience and a total number of impressions desired in a defined timeframe. It may also specify other constraints such as cost, cost per impression, desired or undesired programs or programming networks, time of day for delivery, etc. Of particular importance for present purposes, the campaign parameters may also specify parameters related to pacing such as frequency of asset delivery, minimum spacing between successive deliveries, etc. The campaign may be monitored and fulfilled across multiple networks employing multiple distribution modes, e.g., broadcast and streaming.

In many cases, the targeting parameters are matched to particular network users. This may be done at the UED 106 and/or at another network platform. In the case of matching at the UED 106, such matching may be based on operation of a classifier—that estimates classification parameters (such as demographics) based on channel selection, volume settings, or other user inputs—or may be based on classification parameters provided to the UED 106. In other cases, the matching may be done remotely from the UED. For example, a list may be generated at a network platform of network users that match the targeting parameters. In the illustrated implementation, the matching may be done, for example, at a third-party database platform 110 and/or at the decisioning system 104. The third-party data platform 110 may be a platform that includes demographics, financial, and purchasing behavior information for members of the public, such as the Experian system or another credit reporting company or other government or private agency. Information from such a platform may be used in conjunction with user data 112 to obtain information for network users. This information may be matched to targeting information entered on the order system 102, for example, to generate a list of targeted network users for a particular asset/campaign. It will be appreciated that multiple assets may be a match for any given network user. Accordingly, factors such as pacing may be taken into account in connection with individual delivery decisions.

As noted above, assets may be delivered in conjunction with an asset delivery opportunity of particular programming, e.g., an addressable spot of a commercial break in broadcast television programming. In this regard, the programming may be provided via a programming network 122 such as a cable, satellite, or IP protocol network which may include wireless and/or wireline network elements. Asset options may be multiplexed in the programming signal from the programming delivery network 122 or may be provided by a separate asset delivery network 124 such as an IP protocol network (e.g., the Internet) or multicast structure of the programming delivery or other networks.

The UED 106 may be embodied in a television, a set top box, a computer, or a mobile device such as a telephone or tablet, among other things. Generally, the UED 106 is capable of receiving and delivering programming, selecting or implementing the selection of addressable assets, and reporting asset delivery. In the illustrated embodiment, the UED 106 includes a communications port for obtaining order information 114, storage for storing assets 116, communications ports 118 for receiving programming and assets as well as reporting asset delivery among other things, and a processor 120 for controlling the UED functionality as described herein. The communications ports 118 and port for receiving the order information 114 may include IP communications structure and logic or structure and logic for decoding in-band or out-of-band television network messages. The order information 114 may include, depending on the implementation, pacing information, targeting information, directions concerning what asset to insert at a specified asset delivery opportunity, minimum spacing parameters, etc.

### 2. The Pacing Problem

The asset delivery system described above may include an asset delivery network platform or head-end and a decisioning system which interact with a number of semi-autonomous UEDs. Some number of asset orders are entered into the system, and the number of active orders can vary over time as new orders are added and orders complete. Each asset order specifies a number of required impressions, a time period over which to deliver the impressions, and a subset of the total UEDs that this asset targets, along with a few other miscellaneous criteria and conditions. A fundamental objective is for the system to deliver impressions approximately evenly in time and at least on pace to complete the impression requirement by the end of the time period.

The UEDs are assumed to be viewed such that they generate delivery opportunities in a somewhat predictable process (in a large sense) over time. When an UED is viewing an enabled asset spot (an addressable asset delivery opportunity) it plays an asset in that spot from one of the asset orders that target the UED, and that asset order is accounted as having delivered one impression. In an exemplary implementation, the assets are stored locally, and so are all available to deliver or play, and the UED semi-autonomously selects one. In this regard, the system can be configured so that the effect is that the UEDs will select at uniform random probability from the active available asset orders the one to play in that UED in the delivery opportunity. Such a configuration is engaged purposefully in order to generate system-wide outcomes that can be readily analyzed in the aggregate.

Also, each asset order may optionally have a separation value, an amount of time after it has been played in a UED during which it becomes temporarily inactive and will not play again in that box. This value is available for the purchasers of the asset orders, but can be supplemented to a longer amount of time for purposes of asset pacing. This replacement value is termed the pace-separation of the asset order. The value is identical for all UEDs for each asset order, so one value must be selected for each order that arranges for pacing system-wide. In addition, the effects of these values interact whenever a UED is targeted by more than one asset order, which will be the great majority of UEDs in production systems.

The actual impression deliveries are subject to significant vagarities in production systems. For example, there may be strong correlations between the different asset order subsets, producing a larger than expected load on those UEDs. There may be correlations between the target subsets and the actual rate of delivery opportunities experienced by those particular UEDs. The system may have been informed by incorrect estimates of the number of UEDs that satisfy the targeting parameters. There may be uncertain or delayed transmission of asset order and impression delivery data throughout the system. After all of this, the head-end will receive posterior estimates of the actual UED deliveries of each asset order. From these, it is possible to adjust the asset order parameters online, in order to control the impression delivery outcomes to track the desired delivery goals.

Effectively, the system is provided with a stream of asset orders over time, each defined by a time period, a required number of delivered impressions, and a target subset. There will be times at which the system may send new, updated, or adjusted asset order parameters, and other times at which return impression delivery estimates will arrive. The basic problem is to determine a pace-separation value for each active asset order such that the system, as a whole, will deliver at least the required final total asset impressions for each order by the end of the active time period of the order, while delivering these impressions at an approximately even pace over the active time.

There are a number of secondary considerations for the solution. First, the above determinations should be applicable online over time to adjust the asset order parameters as return impression delivery data provide estimates of actual system impression delivery. The solution should also be able to make admission determinations, either accepting or rejecting new asset orders as they arrive at the system, with rejected orders being ignored for our purposes and never being entered into the system. While rejecting orders is permitted, a solution is preferred if it can reject fewer orders while maintaining required impression delivery for all orders. Finally, during operation, the system may encounter a situation where the set of orders currently in the system are not likely to all successfully complete, and a solution should flag this circumstance for system users, permit manual determinations of estimated order impression delivery (including order dismissal), and possibly arrange a default system response that switches delivery parameters so that the maximum number (or some calculable optimal set) of asset orders will successfully complete.

There are two extra considerations that complicate the models to follow actual system characteristics but do little to fundamentally alter the problem. Each asset order may have fighting constraints, which are definitions of subsets of all available viewing time during which these assets may play, without playing at any other times. Also, the asset of each asset order will have a play length in seconds, with 30 seconds being most common, but 60, 15, and other time periods being possible, and the actual random determination of the asset to play in the UED follows a more complex pattern than the simple model described above. Instead of randomly selecting from among all active assets, in one implementation, the system default is for UEDs to prefer a 60 second asset to two 30 second assets, and to prefer a 30 second asset to two 15 second assets, for the same delivery opportunity time period. Only when no 60 second assets applicable to this UED are active, for example, would the UED begin to select randomly from the 30 second assets. The system does not attempt to cause all assets of varied lengths to be selected from randomly in one pool, although it is possible to configure the system to prioritize the asset pools differently. Thus, the effect can be mitigated by altering available system parameters so that these preferences are temporarily switched, so that for example 30 second assets are preferred over 15 second assets which are preferred over 60 second assets, with a rotation schedule across suitable priority orderings.

The remainder of this section provides a list of variable definitions.

### 2.1 System Constants

Initially, it is assumed that the following are given, although they can change over time:
Total universe of viewers: U
System average delivery opportunity viewing rate per UED (avail per unit time): r^{Ω}
Flighting modification mapping: F: {possible flighting}→(0, 1]
Overall time period of the simulation: [Tₛ,Tₑ)
   The assumption, here, is that the rate r^{Ω} at which delivery opportunities arrive at each UED is constant and equal across UEDs and across time, and that the arrival of delivery opportunities can be modeled as a Poisson process with this given rate. Techniques to relax this assumption are discussed in Section 3.4.

### 2.2 Asset Orders

For each asset order i:
Time period active: [tᵢ^{s},tᵢ^{e})
Target universe: Uᵢ⊂U
Flighting: fᵢ
Number of impressions desired: Iᵢ^{d}
Estimate of number of impressions viewed so far: I_{i,t}^{v}

### 2.3 Solution Goal

Want: pace-separation period length Q_{i,t}≥0 for each asset order at any given time t, so as to approximately satisfy

I_{i,t}_{ᵢ}_{^{e}}^{v}=Iᵢ^{d} (1)

with the desire that if Iᵢ^{v} and Iᵢ^{d} differ, then

I_{i,t}_{ᵢ}_{^{e}}^{v}≥Iᵢ^{d} (2)

The system is also allowed to reject an asset order at the start of its active time period, and that asset order will thereafter be treated as though it never existed. (In a real system, this rejection should occur when the order is first entered.) Better solutions will reject fewer requested orders while completing required delivery.

### 2.4 Target Sets and Independence

The subsets of UEDs out of the universe U that each asset order targets are assumed, for the sake of the problem analysis, to be mutually independent of each other. What this means is that the chance that a particular UED is the target of one asset order is independent of the chance that it is also the target of any other asset order. This is a huge simplification of the correlation structure of asset targeting, but it eases analysis significantly, and we will relax this assumption when providing a control policy to track delivery outcomes to match the re-turned asset delivery data. The assumption allows us to completely characterize the probability that any asset order targets an arbitrary UED as

$${p}_{i} = \frac{\vert {U}_{i} \vert}{\vert U \vert} \qquad ( 3 )$$

independently of which other assets target this UED.

### 2.5 Time Delays and Dependence

In actual system operation, the values that are computed by the solution process will be provided to system components that send that data in ADRs at times given by the system configuration, and there will be some time delay and potential for transmission failure in the communication with the UEDs. Also, the return data on impression delivery will happen at times set by the system configuration and will involve delays and possible data loss, and these data on impression delivery will be estimates of actual values. A full solution may account for the delays and losses in propagation of information from the main system components to the UEDs and back.

Additionally, in real operation some of the above parameters vary over time. For example, the total universe of viewers U is actually a time-dependent variable Uₜ, which varies periodically over the day and week, but can also drift from week to week. Similarly, the avail viewing rates will vary in time. These dependencies may be modeled in a high-fidelity solution.

### 2.6 Computed Asset Order Attributes

This system can immediately calculate for each order i:
Order length Lᵢ=tᵢ^{e}−tᵢ^{s}
Proportion targeted pᵢ=|Uᵢ|/|U|
Rate of desired delivery Rᵢ=Iᵢ^{d}/Lᵢ
   . . . and when required at later times, the system recalculates these as:
Remaining order time L_{i,t}=tᵢ^{e}−(tᵢ^{s}∨t)
Proportion targeted at time t,p_{i,t}=|_{i,t}|/|Uₜ|
Rate of desired delivery at time t,

$${R}_{i , t} = \frac{{I}_{i}^{d} - {I}_{i , t}^{v}}{{L}_{i , t}}$$

### 2.7 Events Requiring Action

Each strategy will need to define how to react to each of the following events:
Entry of a new asset order (i.e. accept/reject).
Start of time period of an asset order.
End of time period of an asset order.
Notification of deliveries. (Ignored for now.)
Request for separation values Qᵢ to use in ADRs.
Request for Asset Importance settings for 15-30-60 asset varieties. (Ignored for now.)

The various strategies for responding to these events and providing the actual values required by the ADRs are described in the next sections.

For now, ADRs are assumed to be transmitted instantaneously to the end user devices and the times are assumed known, as Tₛ≤tₖ<Tₑ.

Note that the updating of ADR values in the UEDs may not happen at a time that coincides with the start of every asset order. What this means is that a new asset order will begin its time period of delivery, being played according to current settings, based on the most recent ADR update. If there is uncertainty as to the timing of ADR updates, then these updates will need to take account of the possibility that there may not be a subsequent update before the next asset order or asset orders enter their period of delivery, and engage in minor predictive behavior.

For now, it is assumed that asset order start and end times coincide with ADR delivery times, and therefore that any ADR delivery times that don't coincide with an asset order start or end time are irrelevant. As a further simplification, it is assumed that asset orders are entered (and possibly rejected) at exactly their start time.

### 2.8 Later Models

In the longer term, system configurations can be provided that require changes in the software of the UEDs in order to improve system pacing behavior. Given that the operation of the UEDs is mutable, decision procedures can be selected within the UEDs that are most amenable to the aggregate system analyses useful for the above procedures. One example is to modify the UEDs to select randomly from applicable asset orders such that the probability of picking each order is proportional to a given system-wide rate parameter for each order. As a further development, the UEDs could be modified to select randomly from the applicable orders such that the choices maintained approximately the declared relative system-wide rates, where for example the chance for an asset to play was taken to be proportional to the extent to which its deliveries at this UED were behind the configured rate of even play over time.

### 3. Problem Analysis

### 3.1 Rates and Time Periods

At many points during this analysis, what is important is the rate that something is occurring within a system component or aggregate of such components. However, the values of interest that are provided or are sought are related to the period of time that something will take to complete, or to return to a prior state in a cycle. The natural relationship between rates and periods is that

$$rate = \frac{1}{period} \qquad ( 4 )$$

For a group of components, their behavior can be aggregated by summing aspects of their behavior, as in the case of expected values, the system is usually performing the equivalent of an arithmetic mean or weighted arithmetic mean. To find an aggregated rate for the system as a whole, the system cannot achieve this by taking an arithmetic mean of the individual rates or period times, and must instead make use of harmonic means.

The harmonic mean of values x₁, . . . , xₙ is defined as

$$H ( {x}_{1} , … {x}_{n} ) = \frac{n}{{\sum }_{i = 1}^{n} \frac{1}{{x}_{i}}} \qquad ( 5 )$$

and the weighted harmonic mean with weights w₁, . . . , wₙ is

$${H}^{w} ( {x}_{1} , {w}_{1} , … , {x}_{n} , {w}_{n} ) = \frac{{\sum }_{i = 1}^{n} {w}_{i}}{{\sum }_{i = 1}^{n} \frac{{w}_{i}}{{x}_{i}}} \qquad ( 6 )$$

Because of the interplay between rates and periods in this problem, the harmonic mean is a common feature in the analysis.

### 3.2 Delivery at a Single UED

Consider the case of just one UED, where there are n of the asset orders targeting this UED. At each delivery opportunity where the UED is being viewed, the UED will select one of the active asset orders to play (or will play a filler or default asset if none are available). The system can be configured so that, generally, the probability to select each of the active assets to play is equal to the probability to select any other: a uniform distribution across these assets. The question arises as to how often an asset order will play in this UED, given the pace-separation values Qᵢ, 1≤i≤n of the asset orders that target this UED.

Once an asset is played, it will be unavailable for play for the length of its separation period Qᵢ, or for an expected number of delivery opportunities Dᵢ equal to the rate of delivery opportunities r^{Ω} times the pace-separation length Qᵢ. After again becoming active, the asset order will wait until the next delivery opportunity arrives. At subsequent delivery opportunities, the probability distribution of being chosen from amongst a pool that maintains a size of k elements is a geometric distribution with expected value k. While the number of asset orders that compete with a given order for delivery will vary over time, there is some expected value that this will approximate. Because of these two factors, the expected amount of time that an asset order will take from delivery to delivery will be in proportion to the sum of these two values, or the pace-separation delay value Dᵢ plus the time waiting for delivery while active, 1+Cᵢ, where the value Cᵢ is equal to the expected number of other asset orders in contention to play at this UED during periods when the i^{th} asset order is active (except see refinements below in Section 3.4). The rate at which this asset order plays in this UED is

$${r}_{i} = \frac{1}{{D}_{i} + 1 + {C}_{i}} \qquad ( 7 )$$

impression deliveries per delivery opportunity. Note that while this is called a rate, here it is really the probability that this asset order will play at each delivery opportunity in this UED.

The addition of 1 in the denominator of this rate equation may appear mysterious, but it is a consequence of our assumption that the delivery opportunities arrive as a Poisson process with constant rate r^{Ω}. At any time that an asset order leaves the inactivity period defined by its pace-separation, the expected amount of time until the next delivery opportunity is a full period of time equal to r^{Ω}, by the memoryless property. This means that asset orders that return to being active will wait an expected amount of time associated with one full delivery opportunity before that next delivery opportunity arrives. Difficulties with the practical application of this assumption at small Dᵢ values are discussed in Section 3.4.

### Theorem 1.

Suppose that delivery opportunities arrive singly at rate r^{Ω} to a UED, and that this UED is targeted by n asset orders with nonzero pace-separation values Qⱼ, 1≤j≤n. The expected rate rᵢ (in impressions per delivery opportunity) at which one of these asset orders i plays in this UED is approximately given by

$${r}_{i} \approx \frac{1}{{D}_{i} + 1 + ( ( n - 1 - {H}_{i} ) 0 )} \qquad ( 8 )$$

where Dᵢ=r^{Ω}Qᵢ and Hᵢ is the harmonic mean of the values Dᵢ, j≠i.

As a convention, the harmonic mean of an empty set will be assigned the value zero. If n=1, then the above equation reduces to rᵢ≈1/(Dᵢ+1). This permits a value of Dᵢ equal to 0, in which case the rate becomes one impression per delivery opportunity, as we expect. The overall equation can be defined to permit zero pace-separation values by replacing the value (n−1−Hᵢ)∨0 with the calculation

Z+(n−1−Z−\tilde{H}ᵢ)∨0 (9)

where Z is the count of pace-separation values other than Qᵢ that are zero and \tilde{H}ᵢ is the harmonic mean of the other pace-separation values that are nonzero.

Necessarily, the above calculation is most applicable when Qᵢ is at least as large as 1/r^{Ω}, the expected time between delivery opportunities at any single UED. As Qᵢ approaches 1/r^{Ω}, practical realities such as the structure of delivery spots into breaks begin to strongly affect the outcomes. However, the following inequality always holds for an asset order in a single UED targeted by n total asset orders:

$$\frac{1}{{r}^{Ω} {Q}_{i} + n} \leq {r}_{i} \leq \frac{1}{{r}^{Ω} {Q}_{i} + 1} \qquad ( 10 )$$

The right inequality says that the asset order cannot play at a faster rate than it would if no other asset orders existed, and the left inequality says that the asset order cannot play more slowly that it would if it were contending against all of the other asset orders that target this UED every time it was active.

### 3.3 System-wide Delivery

### Theorem 2.

Let the pace-separation values in a system be Qᵢ, 1≤i≤N, with associated delivery delay values Dᵢ=r^{Ω}Qᵢ. Define Pᵢ=P({1, . . . , N}\i), where P(X) is the powerset of X. For any set A∈Pᵢ, let |A| be the cardinality or number of elements in A, let H_{A} be the harmonic mean of the values {Dⱼ: j∈A}, and let P(A) be the probability that (other than the asset order with index i) a UED is targeted by exactly and only the asset orders with indices in A. Then

$${\hat{R}}_{i} \approx {r}^{Ω} \vert {U}_{i} \vert ( {\sum }_{A ∈ {P}_{i}} \frac{P ( A )}{{D}_{i} + 1 + ( \vert A \vert - {H}_{A} ) 0} ) \qquad ( 11 )$$

is the expected rate at which asset order i plays in the system as a whole.

This is just an application of the law of total probability. Using these expected delivery rates Rᵢ, the problem can be restated as providing pace-separation values Qᵢ, 1≤i≤N for each asset order in the system so that \hat{R}ᵢ≥Rᵢ for all i. Note that operating as this does through pace-separation determined rates, the system-wide delivery of impressions for any particular order is extremely likely to be approximately even over time, necessarily satisfying another of the problem requirements.

### 3.4 Small Q and the Break-Pace Interaction

Recall the earlier Equation 7. In a real system, there may be additional constraints on when some asset orders can deliver their impressions, called the fighting constraints, and the delivery opportunities do not arrive at UEDs singly at an even rate. Minor modifications can be made to account for both of these features.

It is expected that many or most asset orders will not specify any particular fighting periods. However, in case that some subset of all delivery times are specified for the fighting of some asset orders, one simple way to incorporate these restrictions is to use the value F(fᵢ)r^{Ω} in place of r^{Ω} in the above calculations. A fighting constraint on one asset order will also increase the effective delivery rates for the other asset orders above what the calculations would indicate, but there may be cases where the fighting between two orders overlap in complex ways, and so we neglect this possible improvement of the calculated pace-separation values in order to conservatively predict order acceptance and delivery rates.

More significantly, the model of delivery opportunities described above does not account for the erratic actual arrival of delivery opportunities to real UEDs. In reality, the delivery opportunities are composed together into breaks, and those breaks will be encountered by viewers at strewn times with varied inter-arrival times, and there will be no delivery opportunities at all during the times when members of the household are not watching TV. This has the combined effect of chunking together delivery opportunities into immediate time sequence, and also corralling delivery opportunities at any single UED into a subset of all time, the viewing times. If the system policy is that no asset will be played in a single break more than once, then the maximum rate of impression delivery for a single asset order is at most as frequently as the household views breaks, not as frequently as the household views delivery opportunities.

The chunking together of delivery opportunities into breaks forms what is, from the perspective of pace-separation, an almost zero time difference between some number of consecutive delivery opportunities. For example, suppose that the addressable breaks are all two minutes in length, and the asset orders are all for 30 second assets. Then, each viewed break will enact four delivery opportunities in rapid succession, in a time period smaller than any acceptable pace-separation value. This has the effect of exaggerating the contention relative to what it would be if the delivery opportunities were all evenly spaced in time. Similarly, the corralling of the delivery opportunities experienced at a particular UED into only the time periods when the TV is viewed will also act to exaggerate contention, and for that matter, having positive correlations between asset targeting will also have this effect.

These factors appear to be difficult to model theoretically, and yet there is an easy way to approximate the effect. The circumstances at any particular UED are similar to what would be experienced if some of the assets returned to being active more quickly than would be expected from their pace-separation values. This is because, after delivering some number of assets in quick succession, the UED will have a longer than expected wait time for the next delivery opportunity, as it waits the full time for another break. During that longer time, asset orders with shorter delay periods might have come back into activity and into contention, whereas the models would expect them to likely still be inactive. This can be corrected by artificially introducing an element that reduces the calculated harmonic mean of the delay periods in the above rate equations by some small fixed amount. So, a system-wide parameter B may be selected that is equal to the approximate number of addressable spots per addressable break (minus one), and then add a fixed number like 2 or 3 to this to account for switching between viewing and non-viewing regimes and for potential targeting correlations. Then, in the circumstances of Equation 8 but with relaxed assumptions, the system could instead calculate

$${r}_{i} \approx \frac{1}{{D}_{i} + 1 + ( n - 1 - ( {H}_{i} - B ) 0 ) 0} \qquad ( 12 )$$

This value B is an unfortunate extra global exogenous parameter, but further analysis down this line would be a long project, and the above is sufficient for present purposes.

Finally, the system should probably simply reject orders that could only be expected to complete if they had a very low pace-separation value, which is the case where the operation of that value would lead the above factors to be pertinent. Rejecting orders that have a calculated Dᵢ value less than one, which means a pace-separation value Qᵢ<1/r^{Ω}, is one possible option.

### 3.5 Automatic Control

In an operating production system, the head-end will receive notifications of impression delivery. Given the unpredictable outcomes and violations of analysis assumptions during operation, the delivery estimates are likely to diverge from the desired delivery outcomes. These can be used in a feedback system to control the pace-separation parameters to induce smooth delivery that at least meets delivery requirements. The likely control point is to introduce a factor u_{i,t} into the system rate formula, making it

$${\hat{R}}_{i , t} \approx {u}_{i , t} {r}^{Ω} \vert {U}_{i} \vert ( {\sum }_{A ∈ {P}_{i}} \frac{P ( A )}{{D}_{i} + 1 + ( \vert A \vert - {H}_{A} ) 0} ) \qquad ( 13 )$$

This value u will start at one for each new asset order, and can be updated as feedback is received from delivery notifications so that using the new value will control towards preferred outcomes.

During this process, it may come to pass that the calculated control parameters would require impossible values for pace-delay and pace-separation for one or more orders. In this case, the system can alert system operators that the system has entered a condition in which it is expected that one or more orders will not complete, and may additionally automatically select some number of orders to provisionally terminate such that, even without operator intervention, the remaining orders are expected to successfully complete. The selection of orders to so terminate may follow an optimal selection according to some criteria, such as asset order CPM, buyer priority, or some other detail of the asset order contracts.

In addition to automatic variations of the control parameter, the system may allow an additional, final exogenous modification of the control parameter by a factor determined by the system operator, in order to manually slow down or speed up the delivery of a particular order or some particular orders. As a manual intervention with systemic effects, this may have undesirable consequences for the delivery rates of other orders, but this may be acceptable in some circumstances. The system could also allow the manual premature termination of any asset order.

### 3.6 Later Model Analysis

If the software configuration of the UED may be changed, the operation of these devices can be set to ease the overall analysis and to permit enhanced solutions. Suppose that, instead of selecting at uniform random probability one of the active asset orders to play at each delivery opportunity, the UED selected an asset order to play at random according to the relative probabilities

$${\hat{p}}_{i} = \frac{{r}_{i}^{c}}{{\sum }_{j = 1}^{k} {r}_{j}^{c}} \qquad ( 14 )$$

from amongst all of the k asset orders that target this UED. As before, the per-UED probabilities defined in this procedure are also the rates at which this UED will deliver impressions per delivery opportunity for this asset order. Here, the control rate values rᵢ^{c} are given system-wide so that one value for each order is used by all UEDs, as is the case with the pace-separation values in the prior analysis. It is only the subset of orders that target the UED that varies between UEDs. In this case, the expected rate of impression deliveries \hat{R}ᵢ from the system as a whole is

$${\hat{R}}_{i} = {r}^{Ω} \vert {U}_{i} \vert {\sum }_{A ∈ {P}_{i}} \frac{{r}_{i}^{c} P ( A )}{{r}_{i}^{c} + {\sum }_{j ∈ A} {r}_{j}^{c}} = {r}^{Ω} \vert {U}_{i} \vert {\sum }_{A ∈ {P}_{i}} {r}_{i}^{A} P ( A ) \qquad ( 15 )$$

where here rᵢ^{A} is defined by

$${r}_{i}^{A} = \frac{{r}_{i}^{c}}{{r}_{i}^{c} + {\sum }_{j ∈ A} {r}_{j}^{c}}$$

The delivery rates for the system as a whole are not linear in the value of rᵢ^{c}, but for UEDs that are targeted by many asset orders these rates approach linear in proportion to rᵢ^{c}, and the majority of UEDs in real deployments are likely to be targeted by a number of orders with non-negligible control rates. As more orders are entered into the system, the rate of play of any particular order is likely to stabilize towards approximately the value

$${\hat{R}}_{i} \approx {r}^{Ω} \vert U \vert \frac{{p}_{i} {r}_{i}^{c}}{{\sum }_{j = 1}^{N} {p}_{j} {r}_{j}^{c}} \qquad ( 16 )$$

where the value Σⱼ₌₁^{N}pⱼrⱼ^{c} acts as a system average total impression rate requirement against which the rᵢ^{c} value is normalized. In the context of requiring \hat{R}ᵢ≥Rᵢ for all i, by defining

r̅ᵢ=Σ_{j≠i}pⱼrⱼ^{c} (17)

the following inequality is obtained

$${r}_{i}^{c} \geq \frac{{R}_{i} {\overline{r}}_{i}}{{r}^{Ω} \vert {U}_{i} \vert - {p}_{i} {R}_{i}} \qquad ( 18 )$$

Under alternative choices for the configuration of UED asset play selection, the analysis is similar to the above and provides similar calculations for the rᵢ^{c}. These values rᵢ^{c} can be modified by automatic control, as described in the previous section, to track incidental variations in delivery outcomes as estimated by delivery notifications, and to permit notification alerts and manual interventions in play rates.

### 4. Various Solutions

### 4.1 Static Contention

For this solution, the Dᵢ values are calculated assuming that all other D values are zero and target every UED, so that the asset order will face the maximum possible contention in every UED that it targets. This is most likely of possible solutions to reject asset orders. This is the worst reasonable valid solution; every other solution should reject no more asset orders than this one, and good solutions should perform significantly better by rejecting significantly fewer orders.

To calculate the separation delay value Dᵢ for asset order i, let

$${D}_{i} = \frac{{r}^{Ω} \vert {U}_{i} \vert}{{R}_{i}} - N \qquad ( 19 )$$

where N is the total number of asset orders in the system. Recalculate all of these values using the new total count of asset orders whenever an asset order is added or completes. Reject a new asset order if this value would become zero or less for any asset order. Provide pace-separation values for the system asset orders according to the formula

$${Q}_{i} = \frac{{D}_{i}}{{r}^{Ω}} \qquad ( 20 )$$

### 4.2 Full Optimal Iterated Calculation

Suppose a candidate set of values Qᵢ* with associated delay values Dᵢ* and that we would like to improve these, in the sense that all of the values become at least as large and yet all of the asset orders that previously were expected to deliver above the required rate will still be expected to at least deliver on pace. Define

λᵢ^{A}=Dᵢ*+1+(|A|−H_{A})∨0 (21)

for any subset A of the asset order indexes excluding i, with H_{A} defined as above but using the values from the current candidate set of Dᵢ* values. Then, define

$${λ}_{i}^{*} = \frac{1}{{\sum }_{A} \frac{P ( A )}{{λ}_{i}^{A}}} \qquad ( 22 )$$

the P-weighted harmonic mean of the λᵢ^{A} values.

### Theorem 3.

With the above definitions for λ^{A} and λ*,

$$\frac{1}{{Δ}_{i} + {λ}_{i}^{*}} \leq {\sum }_{A} \frac{P ( A )}{{Δ}_{i} + {λ}_{i}^{A}} \qquad ( 23 )$$

for small positive values of Δᵢ.
So, by ensuring that

$$\frac{{R}_{i}}{{r}^{Ω} \vert {U}_{i} \vert} \leq \frac{1}{{Δ}_{i} + {λ}_{i}^{*}} \qquad ( 24 )$$

then

$${R}_{i} \leq \frac{{r}^{Ω} \vert {U}_{i} \vert}{{Δ}_{i} + {λ}_{i}^{*}} \leq {\hat{R}}_{i} \qquad ( 25 )$$

and on-pace delivery is achieved. To ensure the largest possible increase in the pace-separation values towards the optimal value, select the delta value at equality. This means selecting

$${Δ}_{i}^{m + 1} = \frac{{r}^{Ω} \vert {U}_{i} \vert}{{R}_{i}} - {λ}_{i}^{m} \qquad ( 26 )$$

and then setting Dᵢ^{m+1}=Dᵢ^{m}+Δᵢ^{m+1}.

### Theorem 4.

With λᵢ^{m}, Δᵢ^{m}, and Dᵢ^{m} as defined above, the vector sequence Dᵢ^{m} converges to the largest possible vector of values that is expected to deliver at least on pace.

### Proof.

The function gᵢ(Dᵢ*)=Dᵢ*+Δᵢ, with the values Δᵢ defined as above, has a fixed point at the values where each Δᵢ is zero.

The difficulty with the above analysis is that it leads to a procedure that has computational complexity that is exponential in the number of asset orders in the system, since it requires a summation over all subsets of other asset orders.

However, if it is acceptable to pay that exponential processing cost (perhaps to evaluate test scenarios with a small number of asset orders), then this procedure can be used to compute delay Dᵢ and pace-separation Qᵢ values for asset orders in a working asset delivery system. When a new asset order is entered, new provisional Dᵢ* values are generated by reducing the previous asset order Dᵢ values by one each (with a minimum of zero), including the new asset order in the system with a Dᵢ* value given as in the static case, and performing the above iterated calculation on these Dᵢ* values. If any of the asset orders is left by the iterated algorithm with a zero Dᵢ* value, then the new order is rejected, and the prior asset orders are returned to their previous Dᵢ values. Otherwise, the new order is accepted, and all of the asset orders can be provided with updated pace-separation values Qᵢ=Dᵢ/r^{Ω} valid during the period of the new asset order. When an asset order completes its active time period, it is discarded from the pace-separation calculation system, and the above algorithm is run against the remaining asset orders to possibly increment their Dᵢ and Qᵢ values.

### 4.3 Truncated Iterated Calculation

The harmonic mean is significantly affected by its minimal elements. Let minₖ (Dᵢ, . . . , Dₙ) be the smallest k elements out of D₁, . . . , Dₙ. Then

H(minₖ(Dᵢ, . . . ,Dₙ))≤H(D₁, . . . ,Dₙ)∀k≤n (27)

and furthermore, H(minₖ(.)) is often not a bad approximation for H for many values of k. Motivated by this, we try an approximation to the optimal iterated calculation that has reduced computational complexity.

### Define

Hₖ^{N}^{ⁱ}=H(minₖ({D₁, . . . ,D_{N}}\Dᵢ)) (28)

and

Λₖⁱ=Dᵢ+1+(k−Hₖ^{N}^{ⁱ})∨0 (29)

Then λᵢ^{A}≤Λᵢ^{k} whenever |A|=k, and thus

$${\sum }_{A} \frac{P ( A )}{{λ}_{i}^{A}} \geq {\sum }_{k = 0}^{N - 1} \frac{P ( \vert A \vert = k )}{{Λ}_{k}^{i}} \qquad ( 30 )$$

so that

$${Λ}_{i}^{*} = \frac{1}{{\sum }_{k = 0}^{n - 1} \frac{P ( \vert A \vert - k )}{{Λ}_{k}^{i}}} \geq {λ}_{i}^{*} \qquad ( 31 )$$

and thus Δ values for which

$$\frac{{R}_{i}}{{r}^{Ω} \vert {U}_{i} \vert} \leq \frac{1}{{Δ}_{i} + {Λ}_{i}^{*}} \qquad ( 32 )$$

will ensure

$${R}_{i} \leq \frac{{r}^{Ω} \vert {U}_{i} \vert}{{Δ}_{i} + {Λ}_{i}^{*}} \leq {\hat{R}}_{i} \qquad ( 33 )$$

While it is a lower approximation for possible values for Dᵢ, the Δᵢ values calculated in this method at equality can be used in the above iteration scheme.

The probabilities P(|A|=k) in the above equation are the Poisson binomial coefficients, and can be calculated in O(n log n) time. This produces an overall computational complexity of κ(n² log n).

### 4.4 Harmonic Contention Approximation Calculation

By making assumptions about other pace-separation values and keeping them fixed, a maximum D value can be directly calculated for each asset order.

Recall the discussion of asset delivery rates within a single UED in Section 3.2. If there are n asset orders targeting this UED, then at any delivery opportunity an asset i that targets the UED will be in contention with a minimum of zero and a maximum of n−1 other assets. Hence, the rate at which this asset order plays in this UED at each delivery opportunity will be one of

$${r}_{i} = \{ \frac{1}{{D}_{i} + 1} , or \frac{1}{{D}_{i} + 2} , or … , or \frac{1}{{D}_{i} + n} \} \qquad ( 34 )$$

For this solution, we assume the expected delivery rate is the harmonic mean of these possible options, regardless of the true values of the Dᵢj≠i. Hence,

$${r}_{i} = \frac{1}{{D}_{i} + 1 + \frac{n - 1}{2}} \qquad ( 35 )$$

Using this assumption and thinking as we did for the calculation of Equation 11, it is found that

$${\hat{r}}_{i} = p i ( {\sum }_{A ∈ {P}_{i}} \frac{P ( A )}{{D}_{i} + 1 + \frac{\vert A \vert}{2}} ) \qquad ( 36 )$$

where \hat{r}ᵢ is the average expected rate at which asset order i will play, in impressions per delivery opportunity, per UED, by the law of total probability.

### Theorem 5.

Let the pace-separation delay values and targeted proportions in a system be Dᵢ and pᵢ, 1≤i≤n. We can show that the expected rate at which asset order i plays in any UED being targeted by asset i is

$${\hat{r}}_{i} = p i ( {\sum }_{m = 0}^{n - 1} ( {\sum }_{{j}_{1} < {j}_{2} < … < {j}_{m , \neq i}} ( {\prod }_{l = 1}^{m} {p}_{jl} ) ) {\sum }_{k = 1}^{m + 1} \frac{{( - 1 )}^{m + 1 + k} ( \begin{matrix}m \\ k - 1\end{matrix} )}{{D}_{i} + 1 + \frac{k - 1}{2}} ) \qquad ( 37 )$$

Due to the fact that

$${\sum }_{{i}_{1} < {i}_{2} < … < {i}_{m}} {a}_{{i}_{1}} {a}_{{i}_{2}} … {a}_{{i}_{m}} \leq \frac{1}{m !} {( {\sum }_{i} {a}_{i} )}^{m} for {a}_{i} \geq 0 \qquad ( 38 )$$

an upper bound for the expected rate is

$${\hat{r}}_{i} \approx {p}_{i} ( {\sum }_{m = 0}^{n - 1} \frac{1}{m !} {p}_{i}^{- m} {\sum }_{k = 1}^{m + 1} \frac{{( - 1 )}^{m + 1 + k} ( \begin{matrix}m \\ k - 1\end{matrix} )}{{D}_{i} + 1 + \frac{k - 1}{2}} ) \qquad ( 39 )$$

where p̅ᵢ=Σ_{j=1,j≠i}ⁿpⱼ

Furthermore, by using the fact that

$$\frac{1}{m !} {\sum }_{k = 1}^{m + 1} \frac{{( - 1 )}^{m + 1 + k} ( \begin{matrix}m \\ k - 1\end{matrix} )}{{D}_{i} + 1 + \frac{k - 1}{2}} = 2 \cdot {( - 1 )}^{m} \frac{Γ ( 2 {D}_{i} + 2 )}{Γ ( 2 {D}_{i} + 3 + m )} \qquad ( 40 )$$

where Γ(x)=(x−1)! for any positive integer x, we can rewrite Equation 39 as

$${\hat{r}}_{i} \approx {p}_{i} ( {\sum }_{m = 0}^{n - 1} 2 {p}_{i}^{- m} \frac{Γ ( {D}_{i}^{*} )}{Γ ( {D}_{i}^{*} + m + 1 )} ) \qquad ( 41 )$$

where Dᵢ*=2Dᵢ+2

Let the per-UED desired rate of impression delivery be defined by

$${r}_{i}^{d} = \frac{{I}_{i}^{d}}{{L}_{i} \vert {U}_{i} \vert} \qquad ( 42 )$$

It is desired to determine the pace-separation delay period length Dᵢ≥0 for each asset order at any given time, so that the system can attempt to approximately satisfy

\hat{r}ᵢ=rᵢ^{d} (43)

with the desire that if \hat{r}ᵢ and rᵢ^{d} differ, then

\hat{r}ᵢ≥rᵢ^{d} (44)

which will mean that

\hat{R}ᵢ≥Rᵢ

Hence, Equation 41 is solved for the set of separations that satisfy the inequality of Equation 44, and the maximum satisfying Dᵢ is chosen as the separation delay value for the asset campaign i. The system rejects an asset campaign at the start of its active time period (or at initial order entry) based on calculation of this value; if the calculated separation delay is less than one, then that asset should be rejected.

### 5. Exemplary Processes

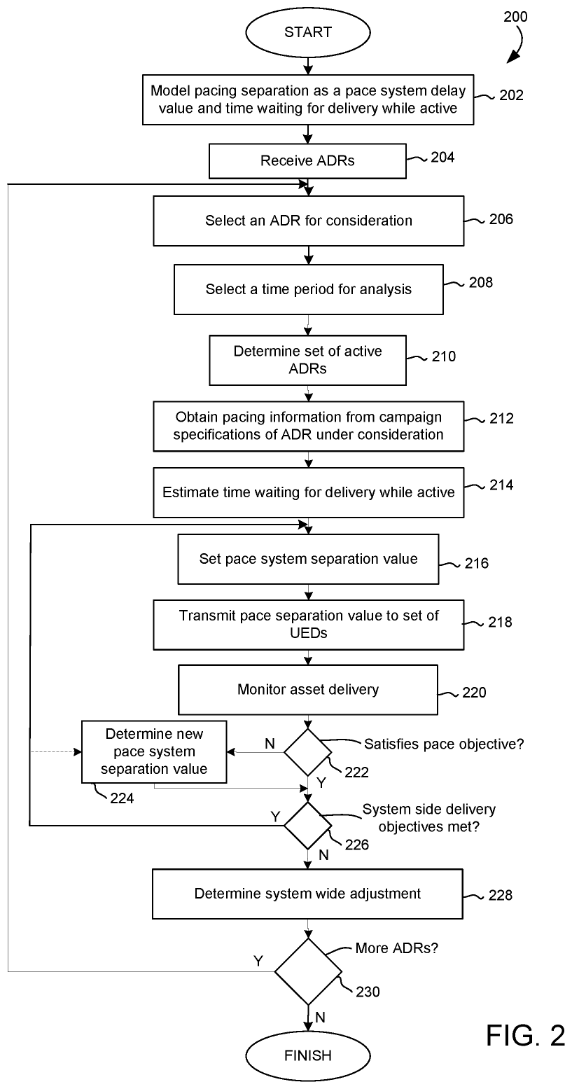

FIG. 2 is a flowchart illustrating a process 200 for pacing asset delivery in a communications network. The process 200 is based, in significant part, on modeling (202) the pacing separation (the nominal time separation between successive deliveries of a given asset by a given UED) as including a pace system delay value and a time waiting for delivery while active. That is, as discussed in the immediately preceding sections, the system includes, in one implementation, a pace system delay value that can be automatically or manually set by the system operator. This value is at least equal to any minimum spacing specification set by the asset provider or other party, and can be extended to achieve the pacing goals of achieving substantially even spacing (within practical constraints) while achieving a delivery pace at least sufficient to timely complete the campaign.

The time waiting for delivery while active is the time that it will take for an asset to be selected for delivery after a prior delivery followed by the time of the pace system delay value. The length of the time waiting while active is affected by, among other things, the total number contending assets (other assets that are active and appropriate for delivery to the same user or users during a given time period), which will vary from user-to-user; the relative probabilities of selection as between contending assets (e.g., uniform or equal probability of delivery any active and appropriate asset); the temporal distribution of addressable asset delivery opportunities; any flighting constraints; and times when the user is available for asset delivery. The actual pacing separation is the sum of the pace system delay value and the time waiting while active.

The process 200 further involves receiving (204) asset delivery requests (ADRs). For example, the ADRs may be entered by asset providers at an asset delivery order system. In addressable asset delivery system, the ADRs will generally include campaign specifications including the total number of impressions desired, the time period over which the campaign will run (e.g., one week), and targeting parameters that define a subset of the network users to whom the asset is targeted. In practical systems, many ADRs will be active at a given time, though the campaign start and end times may vary for different assets.

The pacing functionality then proceeds by selecting (206) an ADR for consideration. ADRs may be considered in the order received, in the order that the associated campaign start time is encountered in sequential processing of an ADR stream, based on a defined priority for consideration (e.g., depending on potential revenues or contract priority) or other basis. Different sequences of consideration may be iteratively implemented as part of an optimization routine.

As noted above, different sets of ADRs may be active at different times. Accordingly, the analysis may differ depending on the time period under analysis and some time period is thus selected (208). The time period may be dependent on the campaign specification (e.g., the campaign duration or defined portion thereof) or independent of the campaign specification (e.g., a day, an hour or other temporal unit for progressive sequential consideration). As otherwise noted herein, pacing values may vary during a campaign. Based on the selected time period, a set of active ADRs may be determined (210). For example, all ADRs that are active during at least a portion of the time period may be identified.

For an ADR under consideration, pacing information may be obtained (212) from the campaign specifications. For example, a nominal pace value may be determined from the total desired impressions and campaign duration. In addition, the campaign may specify a minimum separation between deliveries. In many cases, such a minimum separation may function as a limit on the pace system delay value to avoid the statistical possibility of a minimum separation violation (alternatively, the system may allow and account for some possibility of a minimum separation violation, for example, if revenues are thereby enhanced without unacceptable consequences).

As described above, the actual pacing separation is based on the pace system delay value, which functions as a system control element, and the time waiting while active. Accordingly, to select an initial pace system delay value, the system may first initiate (214) a time waiting while active using the computational model described above. An initial pace system separation value can then be set (216). As described above, all active ADRs may be considered in determining these values.

In one implementation, the pace system separation values can then be sent to some or all UEDs implementing the addressable asset delivery system. For example, all pace system separation values for all assets may be sent to all UEDs, e.g., in a table format. Alternatively, pace system separation values for any given asset may be sent to only those UEDs that are identified to store or deliver the asset. As a still further alternative, UEDs may periodically query the decisioning system for current pace system delay values for all assets that are stored at the UED. It will be appreciated that pace system delay values may not be transmitted to UEDs where delivery decisions are made for the UEDs at the decisioning system or another remote platform.

The system can then continually monitor (220) asset delivery. As described in detail in applications and patents noted above and incorporated herein by reference, some or all of the UEDs may report asset delivery. Such reporting may be implemented via messaging within the programming delivery network or via a separate network such as the internet. To reduce messaging overhead, reporting may only be executed by a statistically adequate sampling of the UEDs in some cases. The reporting can simply indicate asset delivery or may include other information such as audience classification parameters, asset skipping information, or estimated interest level. System rules can be used to determine what reporting details will be counted as a delivered impression or partial impression (if allowed). Such monitoring will typically involve aggregating report information to keep a running tally of impressions delivered for each asset under analysis.

Based on these reports, the system may then determine (222) whether the actual delivery pace reflected by the reports satisfies pace objectives. Due to the vagarities in the context of addressable asset delivery as discussed above, the actual delivery pace may be greater or less than expected. For example, the actual delivery pace may be too low to complete the campaign within the allotted time suggesting that the pace of delivery needs to be accelerated. For other cases, the actual delivery pace may be faster then expected. In such cases, it might be desired to decelerate the delivery rate, e.g., to effect more even distribution of deliveries over the full campaign period or to make room for more ADRs. In any such case, a new pace system separation value may be selected (224), for example, it may be reduced to accelerate pace or increased to decelerate pace.

Optimally, pace system separation vales, and changes thereto for particular ADRs, are not made in isolation but also take into consideration (226) certain system wide objectives. For example, an increase in pace (decrease in pace system separation values) for one or more ADRs may result in an inability to fulfil all ADRs. In such cases, a decision may need to be made as to what ADRs to leave unfulfilled, to what extent ADRs may be left unfulfilled, or whether ADRs need to be canceled. Similarly, in such cases, the system may be undesirably limited in accepting new ADRs. In other cases, pace may by accelerated, within limitations, during a time of sparse demand to make room for meeting pace requirements for as many ADRs as possible in another period of higher demand. All such factors may be taken into consideration in confirming or modifying a pace system delay value. In some cases, it may be determined (226) that a system wide adjustment is necessary, e.g., due to a system wide pace trend or to propagate the effects of a change in pace system delay value for one ADR across contending or all ADRs. This process may then be repeated (230) for additional ADRs as necessary.

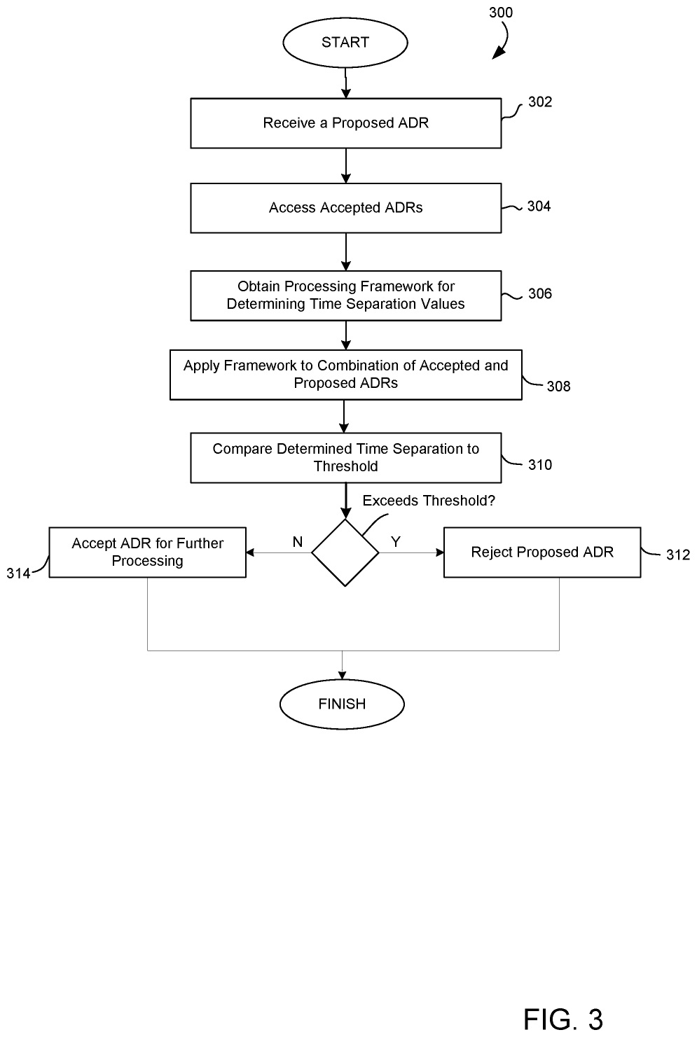

The pacing system can also be used to control the asset delivery order system to accept or reject new ADRs as shown in FIG. 3. The illustrated process 300 is initiated by receiving (302) a proposed ADR. The ADR will generally specify a total number of impressions to be delivered within a defined campaign timeframe, and the processing framework set forth above can be used to determine whether the ADR can be accommodated. In this regard, the pacing system can access (304) accepted ADRs that overlap a time period under consideration, and obtain (306) the processing framework described above for determining pacing information. The framework can then be applied (308) to the combination of accepted ADRs and the proposed new ADR.

There are various ways that this analysis may be used to determine if the new ADR can be accepted. In the illustrated process, the framework is used to determine one or more new resulting pacing system separation values, e.g., for the new ADR or all ADRs. Such values can then be compared (310) to thresholds to determine (316) whether they exceed the thresholds. For example, if the pace system delay value for the new ADR is sufficient to fulfill the campaign the ADR may be accepted (314) and, if not, it may be rejected. Alternatively, all ADRs may be considered to determine if accepting the new ADR would impair the system's ability to fulfil any campaign. Other thresholds may be utilized, for example, if any campaigns have minimum and maximum delivery or expense goals or flexible campaign timeframes.

The foregoing description of the present invention has been presented for the purpose of illustration and description. Furthermore, the description is not intended to limit the invention to the form disclosed herein. Consequently, variations and modifications commensurate with the above teachings, and skill and knowledge of the relevant art are within the scope of the present invention. The embodiments described herein above are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

1. A method for use in pacing the delivery of assets in a communications network, comprising:
developing a model for determining a pacing system time separation for successive deliveries of an addressable asset in said communication network as a function of a pace system delay value and a second time component;
selecting a first asset delivery request and a time period relative to the asset delivery request for consideration, where the asset delivery request includes impression information concerning a desired number of impressions for a first asset and an associated campaign and timeframe information concerning a timeframe of said campaign;
based on said time period, identifying a set of second asset delivery requests for consideration;
using information regarding said first asset delivery request and said set of second asset delivery requests on said model to determine a first pace system delay value for said first asset delivery request; and
using the first pacing system delay value to pace the successive delivery of the first asset at each of a set of user equipment devices.

2. The method of claim 1, wherein said second asset delivery requests involves requests to deliver assets that overlap said time period.

3. The method of claim 1, wherein said second asset delivery requests include requests for delivering assets that are stored at a location of a user equipment device.

4. The method of claim 1, wherein said desired number of impressions comprises a total number of deliveries, across at least said communication network, for said first asset that is requested by an asset provider.

5. The method of claim 1, wherein said time period comprises one of a defined campaign time period of an asset provider of said campaign for said first asset and a subset of said campaign time period used for monitoring campaign progress.

6. The method of claim 1, wherein said pacing system delay value defines a period of time after delivery of said first asset by said first user equipment device where said first asset is unavailable for delivery by said first user equipment device.

7. The method of claim 1, wherein said pacing system delay value defines a period of time after delivery of said first asset to a first network user where said first asset is unavailable for delivery to said first user.

8. The method of claim 1, said model is operative such that each active asset that is available for delivery in connection with a first asset selection event has a substantially equal likelihood of being selected for said first asset selection event.

9. The method of claim 1, further comprising:
monitoring an actual delivery parameter for said first asset across a set of user equipment devices; and
selectively adjusting said first pacing system separation value based on said monitored actual delivery parameter.

10. The method of claim 9, wherein said monitoring comprises receiving delivery reports concerning asset delivery from at least a portion of said set of user equipment devices.

11. The method of claim 9, wherein said adjusting comprises changing said delivery separation time provided to a first user equipment device.

12. The method of claim 11, wherein said adjusting comprises changing said delivery separation time provided to all of said set of managed user equipment devices.

13. The method of claim 1, wherein said second time component relates to an expected amount of time between when said first asset becomes active due to passage of the first pacing system delay value and when said first asset is selected for delivery.

14. An apparatus for use in pacing the delivery of assets in a communications network, comprising:
a pacing system for a user equipment device of a set of managed user equipment devices of said communications network, said pacing system being operative for:
identifying a set of assets that are available for delivery in connection with a first asset delivery opportunity of a set of asset delivery opportunities;
determining, in connection with said first asset delivery opportunity, a set of active asset delivery requests, where each asset delivery request identifies a particular asset and is associated with an aggregate delivery target regarding a desired number of deliveries of said particular asset, and a delivery time period for satisfying said desired number of deliveries;
establishing, for each said user equipment device of said set of managed user equipment devices, an asset selection process such that each active asset of said active asset delivery requests has a substantially uniform probability of being selected for each asset selection event associated with said set of asset delivery opportunities;
determining, for each said user equipment device of said set of managed user equipment devices, separation information relating to a delivery separation time wherein, for each said user equipment device, a time separation between successive deliveries of a first asset is a function of a determinant portion based on said time separation and an undeterminant portion based on said selection process that depends on said substantially uniform probability;
monitoring an actual delivery parameter for said first asset across said set of managed user equipment devices; and
selectively adjusting said separation information based on said monitored actual delivery parameter.

15. The apparatus of claim 14, wherein said set of assets comprises assets that are accessible by said user equipment device.

16. The apparatus of claim 14, wherein said set of assets comprises assets that are stored at a location of said user equipment device.

17. The apparatus of claim 14, wherein said aggregate delivery target comprises a total number of deliveries, across at least a portion of said communication network, for said particular assets that are requested by an asset provider.

18. The apparatus of claim 14, wherein said delivery time period comprises one of a defined campaign time period of an asset provider of a campaign for said particular asset and a subset of said campaign time period used for monitoring campaign progress.

19. The apparatus of claim 14, wherein said separation time defines a period of time after delivery of said first asset by said first user equipment device where said first asset is unavailable for delivery by said first user equipment device.

20. The apparatus of claim 14, wherein said separation time defines a period of time after delivery of said first asset to a first network user where said first asset is unavailable for delivery to said first user.

21. The apparatus of claim 14, said asset selection process is operative such that each active asset that is available for delivery in connection with a first asset selection event has a substantially equal likelihood of being selected for said first asset selection event.

22. The apparatus of claim 14, wherein said monitoring comprises receiving delivery reports concerning asset delivery from at least a portion of said set of managed user equipment devices.

23. The apparatus of claim 14, wherein said adjusting comprises changing said delivery separation time provided to a first user equipment device.

24. The apparatus of claim 23, wherein said adjusting comprises changing said delivery separation time provided to all of said set of managed user equipment devices.

25. A method for use in administering the supply of asset delivery requests accepted in a communications network environment where the cumulative capacity to satisfy such requests is uncertain, comprising:
receiving, at a network platform, a proposed asset delivery request, said asset delivery request concerning delivery of at least one asset to users of said communications network during a proposed asset delivery time period;
accessing, at said platform, a set of accepted asset delivery requests, each concerning delivery of one or more assets to users of said communications network during at least a portion of said proposed asset delivery time period, each of said accepted asset delivery requests and said proposed asset delivery request having delivery parameters including at least an aggregate delivery target regarding a desired number of deliveries of a particular asset and a delivery time period for satisfying said desired number of deliveries;
establishing a framework for pacing the delivery of assets in said communications network so as to achieve a pacing objective while satisfying the delivery parameters of asset delivery requests under consideration, said framework providing base time separation values, each concerning a time separation between successive deliveries of a given asset to a given user, for use in pacing asset delivery;
applying said framework to the proposed combination of said set of asset delivery requests and said proposed asset delivery request to obtain projected base time separation values for the proposed combination; and
making a determination regarding administration of asset delivery requests based on said projected base time separation values.

26. The method of claim 25, wherein said determination involves determining that said communications network cannot satisfy all of the delivery parameters of said proposed combination.

27. The method of claim 26, wherein said determination is based on comparing said projected base time separation values to a threshold.

28. The method of claim 27, wherein one of said threshold is based on a minimum time separation specified in an asset delivery request of said proposed combination.

29. The method of claim 27, wherein said threshold is zero.

30. The method of claim 25, wherein said determination comprises rejecting said proposed asset delivery request.

31. The method of claim 25, wherein said determination comprises one of modifying or canceling at least one of said accepted asset delivery requests.
